(19) United States
(12) Patent Application Publication
(10) Pub. No.: US 2024/0184889 A1
(43) Pub. Date: Jun. 6, 2024

(54) Concept for Erasing User Data

(71) Applicants: Highland Mary MOUNTAIN, Flagstaff, AZ (US); Hector LLORENS, Beaverton, OR (US); Garritt BINDER, Loomis, CA (US)

(72) Inventors: Highland Mary MOUNTAIN, Flagstaff, AZ (US); Hector LLORENS, Beaverton, OR (US); Garritt BINDER, Loomis, CA (US)

(21) Appl. No.: 18/391,707

(22) Filed: Dec. 21, 2023

Related U.S. Application Data
(60) Provisional application No. 63/518,890, filed on Aug. 11, 2023.

(51) Int. Cl. G06F 21/57; G06F 21/62

(52) U.S. Cl. CPC G06F 21/572; G06F 21/6245

(57) ABSTRACT

Some aspects of the present disclosure relate to an apparatus for a computer system, the apparatus comprising processor circuitry to provide, via an interface of a firmware of the computer system, an option to erase user data of the computer system, and erase, after the option has been triggered, the user data of the computer system, wherein erasing the user data of the computer system comprises erasing user data managed by a non-operating system component of the computer system and erasing user data managed by an operating system of the computer system.

### BACKGROUND

Some platform UEFI (Unified Extensible Firmware Interface) BIOS (Basic Input/Output System)-based erase methods blindly remove the OS (Operating System) as well as user personal data when erasing storage media. To restore the device to a usable operating state, someone with OS install know-how and the associated OS licensing key may be required. Without the knowledgeable person with the correct license, the PC is inoperable after erase operation. This situation would frustrate a typical home user and many business users without IT (Information Technology) support.

### BRIEF DESCRIPTION OF THE FIGURES

Some examples of apparatuses and/or methods will be described in the following by way of example only, and with reference to the accompanying figures, in which:

FIG. 1a shows a schematic diagram of an example of an apparatus or device for a computer system, and of the computer system comprising the apparatus or device;

FIG. 1b shows a flow chart of an example of a method for a computer system;

FIG. 2a shows a schematic diagram of an example of an apparatus or device for a remote erasure server, and of the remote erasure server comprising the apparatus or device;

FIG. 2b shows a flow chart of an example of a method for a remote erasure server; and

FIG. 3 shows a schematic diagram of an example of platform hardware Sanitization while preserving or restoring the Personal Computer OS.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

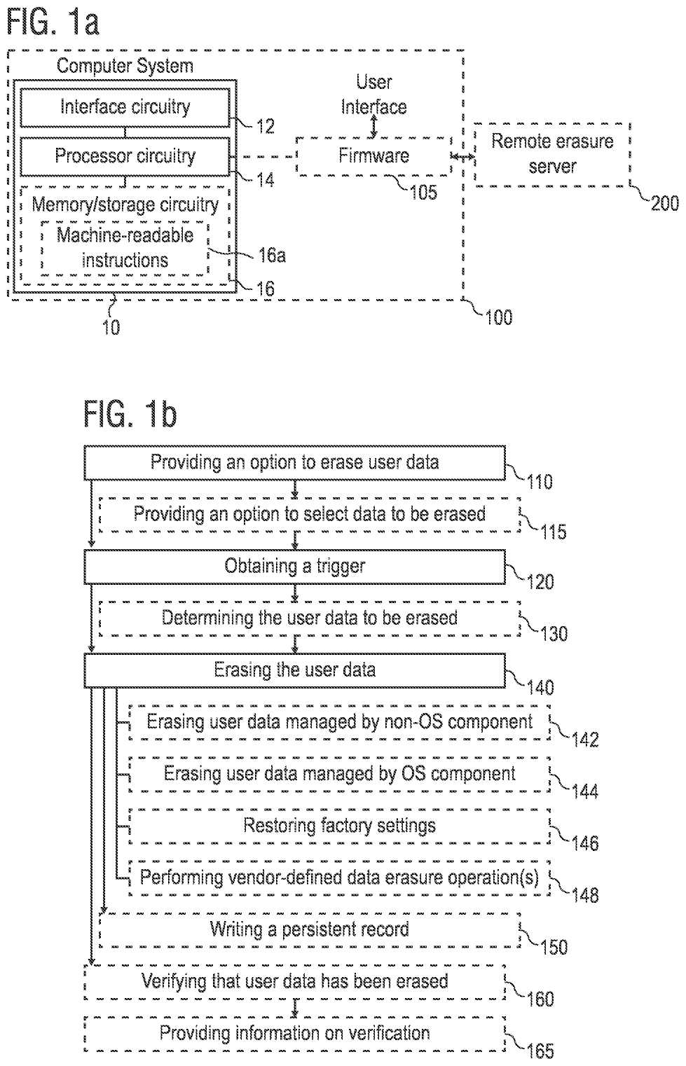

FIG. 1a shows a schematic diagram of an example of an apparatus 10 or device 10 for a computer system 100, and of the computer system 100 comprising the apparatus 10 or device 10. The apparatus 10 comprises circuitry to provide the functionality of the apparatus 10. For example, the circuitry of the apparatus 10 may be configured to provide the functionality of the apparatus 10. For example, the apparatus 10 of FIG. 1a comprises interface circuitry 12, processor circuitry 14, and (optional) memory/storage circuitry 16. For example, the processor circuitry 14 may be coupled with the interface circuitry 12 and/or with the memory/storage circuitry 16. For example, the processor circuitry 14 may provide the functionality of the apparatus, in conjunction with the interface circuitry 12 (for communicating with other entities inside or outside the computing device 100, such as a remote erasure server 200), and the memory/storage circuitry 16 (for storing information, such as machine-readable instructions). Likewise, the device 10 may comprise means for providing the functionality of the device 10. For example, the means may be configured to provide the functionality of the device 10. The components of the device 10 are defined as component means, which may correspond to, or implemented by, the respective structural components of the apparatus 10. For example, the device 10 of FIG. 1a comprises means for processing 14, which may correspond to or be implemented by the processor circuitry 14, means for communicating 12, which may correspond to or be implemented by the interface circuitry 12, (optional) means for storing information 16, which may correspond to or be implemented by the memory or storage circuitry 16. In general, the functionality of the processor circuitry 14 or means for processing 14 may be implemented by the processor circuitry 14 or means for processing 14 executing machine-readable instructions. Accordingly, any feature ascribed to the processor circuitry 14 or means for processing 14 may be defined by one or more instructions of a plurality of machine-readable instructions. The apparatus 10 or device 10 may comprise the machine-readable instructions 16a, e.g., within the memory or storage circuitry 16 or means for storing information 16.

The processor circuitry 14 or means for processing 14 is to provide, via an interface of a firmware 105 of the computer system, an option to erase user data of the computer system. The processor circuitry 14 or means for processing 14 is to erase, after the option has been triggered, the user data of the computer system. Erasing the user data of the computer system comprises erasing user data managed by a non-operating system component of the computer system and erasing user data managed by an operating system of the computer system.

FIG. 1b shows a flow chart of an example of a corresponding method for a computer system 100. The method comprises providing 110, via the interface of the firmware 105 of the computer system, the option to erase user data of the computer system. The method comprises erasing 140, after the option has been triggered 120, the user data of the computer system. Erasing the user data of the computer system comprises erasing 142 the user data managed by the non-operating system component of the computer system and erasing 144 the user data managed by an operating system of the computer system. For example, the method may be performed by the computer system 100, e.g., by the apparatus 10 or device 10 of the computer system.

In the following, the features of the apparatus 10, device 10, computer system 100, method, and of a corresponding computer program will be discussed in more detail with reference to the apparatus 10. Accordingly, features introduced in connection with the apparatus 10 may likewise be included in the corresponding device 10, computer system 100, method and computer program.

Various examples of the present disclosure relate to a sanitization of computer systems, such as desktop computers, laptop computers, workstation computers, workstation computers etc., for the purpose of re-use or data security before disposal. Erasing data from a computer system before resale or disposal serves several important purposes, such as data privacy protection, data security, compliance with regulations, prevention of data recovery, true transfer of ownership and protection of personal and business reputation. While this principle is widely understood, it is, in many cases with respect to computer systems, easier said than done, e.g., if the vendor of the operating system, the vendor of the UEFI/BIOS, vendor of the platform (e.g., the processor manufacturer), and vendor of the computer system are separate entities, which separately control where user data is being stored. In other words, the firmware (e.g., UEFI/BIOS), the operating system, and the trusted platform module of the computer system may be provided by different vendors. While each of the respective components (UEFI/BIOS, OS, platform security elements etc.) generally provide functionality for erasing and restoring them to a factory default, there is, in general, no link between the disparate functionalities. Therefore, even thorough and well-meaning operators may overlook some pieces of user data that remains on the computer system, even after the operator has attempted to erase the user data from the system. In this context, user data is data that is stored in response to the user using the computer system. This can be data that is explicitly stored by the user, and, outside the purview of the operating system, data that is implicitly generated due to the use of the computer system by the user.

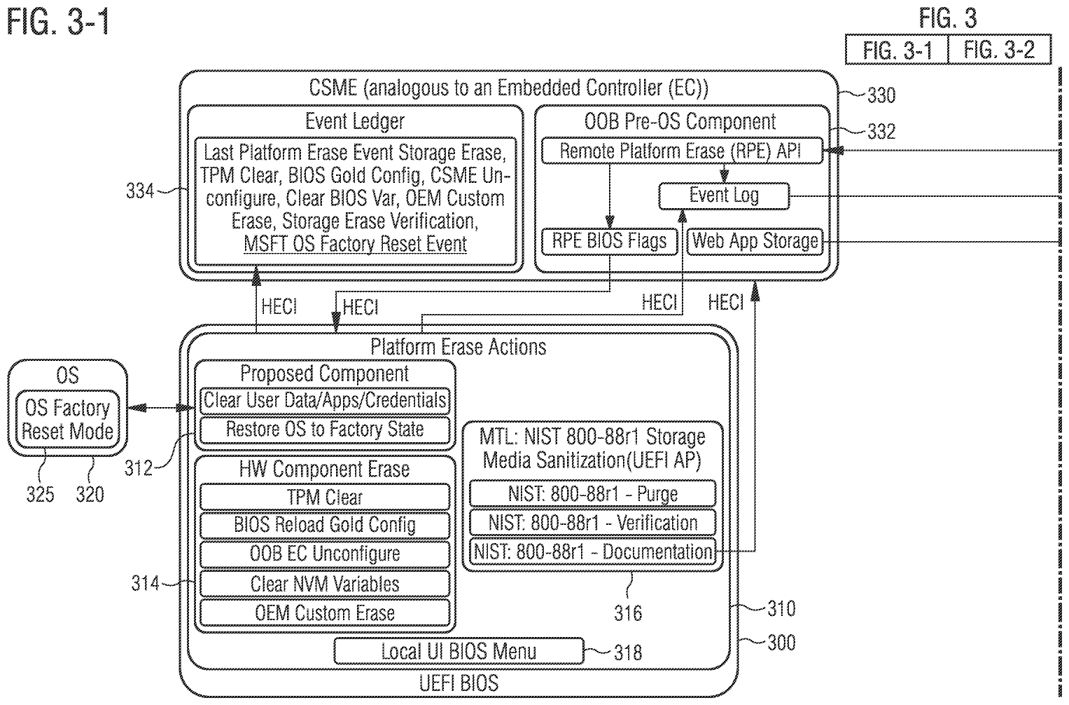

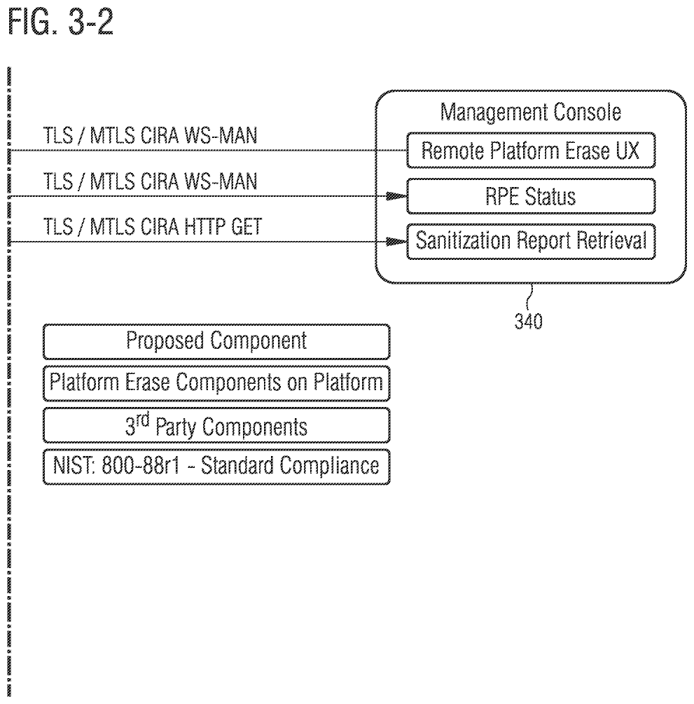

In the proposed concept, this process is facilitated by providing an option, e.g., via a firmware of the computer system, to erase the user data from the computer system, with this option covering both aspects controlled by the OS and aspects outside the scope of the operating system, to ensure that all user data can be safely and easily removed. In the proposed concept, the processor circuitry provides, via an interface of a firmware 105 of the computer system, an option to erase user data of the computer system. Firmware is a type of software that provides the low-level control for a device's specific hardware. In the context of a computer, firmware is typically found in essential systems such as the BIOS (Basic Input/Output System) or UEFI (Unified Extensible Firmware Interface), which start up the computer and manage data flow between the operating system and attached devices such as the hard disk, video adapter, keyboard, mouse, and printer. Accordingly, the option may be provided by a Unified Extensible Firmware Interface, UEFI, of the computer system and/or a Basic Input/Output System, BIOS, of the computer system. Another type of firmware sometimes denoted Embedded Controller (EC) is responsible for enabling remote management of the computer system. This type of firmware may also be used for providing (at least some aspects) of the proposed functionality. In other words, the option may be provided by a remote management firmware of the computer system, such as the Converged Management and Security Engine (CSME) in Intel® computer systems. An example of such a remote management firmware 330 (being implemented by a CSME) is shown in FIG. 3. The corresponding remote management server is shown as management console 340 in FIG. 3.

In the proposed concept, the broad term “interface” is used, as there are multiple different options for exposing the option. For example, the option may be provided via a user interface provided by the firmware. In other words, the processor circuitry may provide, via a user interface of the firmware of the computer system, the option for a user of the computer system to erase the user data as a menu option. The processor circuitry may erase, after the user has triggered the menu option, the user data of the computer system. For example, the option may be exposed via the UEFI or the BIOS of the computer system. Another possibility, which may be used additionally or as an alternative, is to provide an API or hook for the OS of the computer system, such that the user can trigger, via the operating system, erasure of the user data also in parts of the system that are managed by a non-operating system component of the computer system. Accordingly, the processor circuitry may provide, via the interface of the firmware of the computer system, the option to erase the user data of the computer system via an operating system of the computer system (e.g., by providing an API or system hook that is exposed towards the operating system). The processor circuitry may erase, after the option has been triggered via the operating system, the user data of the computer system. A third possibility, which may be used additionally or as an alternative, may be to expose the erasure of user data to a remote erasure service, e.g., via the remote management firmware of the computer system. In other words, the processor circuitry may provide, via the interface of the firmware of the computer system (e.g., by providing an API in the remote management firmware), the option to erase the user data of the computer system via a remote erasure server (e.g., remote erasure server 200) or a remote management system. The processor circuitry may erase, after the option has been triggered via the remote erasure server or the remote management system, the user data of the computer system. Depending on which interface is provided, a corresponding trigger is obtained from the user (or administrator performing the erasure procedure). Accordingly, as further shown in FIG. 1b, the method comprises obtaining 120 the trigger via the interface.

After the trigger has been received (e.g., in response to the trigger being received), the user data of the computer system is being erased. In the proposed concept, this erasure of data comprises (at least) two different components—erasing the data managed by a non-operating system component of the computer system, and erasing the data managed by the operating system of the computer system. In the former case, various pieces of user data are to be considered that are managed by a non-OS component of the computer system, such as a security module, the firmware (e.g., BIOS, UEFI, remote management firmware etc.), a hardware module included by a vendor of the computer system etc., as, outside the purview of the operating system, user data can be stored in various places. For example, in FIG. 3, the functionality for performing erasure of non-OS managed user data is shown by the hardware component erase block 314.

For example, user data can be stored in security-related functionality of the computer system. For example, user data can be stored in (e.g., contained in) a trusted platform module (TPM), a trusted execution environment (TEE) of the computer system or a security engine of the computer system. A TPM is a specialized chip on an endpoint device that provides hardware-based security features. It is designed to secure hardware by integrating cryptographic keys into devices. TPMs provide a host of security functions, including secure generation of cryptographic keys, the ability to securely store sensitive data, attestation (creating a digital signature of system components to affirm the system's integrity), and ensuring a hardware-based trust chain. Erasing user data from the TPM may include erasing stored cryptographic keys or attestation information from the TPM. A TEE is an area within a processor that provides a secure environment where the operating system and applications can run protected from the rest of the device's software. For example, erasing user data from the TEE may comprise erasing any data stored within the TEE. A security engine generally refers to a system or a hardware component within a device that facilitates various security functions. These functions can include encryption, decryption, secure boot, cryptographic key management, and secure execution of code. For example, erasing user data from the from the security engine may comprise erasing cryptographic information (e.g., one or more cryptographic keys) from the security engine. In general, in addition to (or to implement the erasure), the respective components (TPM, TEE and/or security engine) may be reset to (factory) default.

Other user data managed by non-OS components includes variables, user settings and/or authentication information being managed by the firmware of the computer system. For example, erasing the user data managed by a non-operating system component of the computer system may include erasing and/or restoring to a default at least one of user configuration settings stored in a non-volatile memory (NVM) of the computer system, user configuration settings stored by a firmware or firmware application of the computer system (e.g., by the UEFI, BIOS, or remote management firmware), and user data related to one or more authentication variables. All of these settings can be erased, e.g., by erasing the respective settings and/or overwriting them with factory defaults.

Apart from the security-related information and the information managed by the firmware, the vendor of the computer system may also store user data outside the scope of the operating system, e.g., in an embedded controller. As the location and access to such information is only known to the vendor, the vendor may specify which information is to be erased or restored to factory defaults. For example, erasing the user data may comprise performing one or more user data erasure operations defined by a vendor of the computer system. Accordingly, as further shown in FIG. 1b, erasing the user data may comprise performing 148 one or more user data erasure operations defined by the vendor of the computer system. For example, the vendor may provide an UEFI application for performing the one or more user data erasure operations defined by the vendor of the computer system. For example, the one or more user data erasure operations defined by the vendor of the computer system may include operations to restore the respective information to factory default.

In effect, as has already been outlined in connection with the security-related information, erasing the user data managed by a non-operating system component of the computer system may comprise restoring factory settings of the computer system. Accordingly, as further shown in FIG. 1b, erasing the user data managed by a non-operating system component of the computer system may comprise restoring 146 the factory settings of the computer system.

In addition to erasing the data stored outside the purview of the operating system, the processor circuitry further erases user data managed by an operating system of the computer system. In this case, implementation of the functionality may be offloaded to the operating system itself. In other words, the OS may expose one or more hooks and/or APIs for triggering erasure of the user data managed by the operating system (which may include user profile(s), installed software, and data stored on a hard drive that is not part of a factory default). Erasing user data managed by the operating system of the computer system may comprise triggering the operating system of the computer system to erase the user data managed by the operating system. In some cases, e.g., when the trigger is obtained via the operating system, the OS does not have to be “triggered back” by the firmware. Instead, it can be assumed that the OS does already perform the respective erasure of user data. In other words, in case the trigger is obtained from the operating system of the computer system, erasing the user data managed by the operating system of the computer system may be triggered and performed by the operating system, without the firmware having to trigger erasing the user data managed by the operating system. As outlined in connection with the non-OS-managed user data, also the OS can be reset to factory defaults as a result of the erasure (or as a means to implement the erasure process). In other words, erasing the user data managed by the OS of the computer system may comprise restoring 146 factory settings of the OS. The operating system of the computer system itself may be preserved or reset to a factory default when the user data is erased, so that the computer system can be used by a subsequent user after the user data has been erased.

It is evident from the above description that there are numerous places outside the operating system where user data can be stored. To facilitate determining, which user data is to be erased, information can be provided by a platform vendor (e.g., a vendor of the processor, remote management firmware, i.e., a “platform” of the computer system) on which user data is being stored by the computer system. For example, the processor circuitry may determine the user data to be erased based on information on a proposal of user data to be erased by a platform vendor of the computer system. Accordingly, the method may comprise determining 130 the user data to be erased based on information on a proposal of user data to be erased by a platform vendor of the computer system. For example, the platform vendor may provide a framework with suggestions of user data that is to be sanitized (i.e., erased).

In some cases, it may be useful to not erase all user data. For example, user data relating to a registration of the computer system in an enterprise remote management system may be kept, such that the computer system does not have to be enrolled in the enterprise remote management system, allowing for a remote setup of the computer system for a new user. In another example, in a gaming computer system, some firmware settings may be kept that relate to voltage and clock settings that are beneficial to system performance. In a third example, the user may omit a licensing key of the operating system from erasing. For such and other use cases, an option may be provided to select which user data has to be restored. For example, the processor circuitry may provide, via the interface, an option to select which user data is to be erased. Accordingly, as further shown in FIG. 1b, the method may comprise providing 115, via the interface, an option to select which user data may be to be erased. For example, this additional option may be exposed via the user interface, via the interface for the remote erasure server or remote management system, or via the API or hook for the operating system.

In some cases, in addition to performing the erasure of the user data, documentation may be generated and stored that allows third parties to verify that and when the user data has been erased. For example, the processor circuitry may write a persistent record of a timestamp of when the user data has been erased to a storage circuitry (e.g., storage circuitry 16) of the computer system. Accordingly, as further shown in FIG. 1b, the method may comprise writing 150 a persistent record of a timestamp of when the user data has been erased to a storage circuitry of the computer system. For example, an example for this is shown in FIG. 3, where the persistent record is stored in an event ledger 334 of the CSME 330 being used as embedded controller in the architecture of FIG. 3.

In addition to (or in lieu of) documenting the erasure procedure, the processor circuitry may also verify that the user data has actually been erased. For example, the processor circuitry may verify that the user data has been erased. Accordingly, the method may comprise verifying 160 that the user data has been erased. For example, this can be done by checking whether the respective components (OS, firmware, security component, vendor-specific controller etc.) confirm towards the firmware that the respective user data has been erased. The processor circuitry may then provide information on the verification that the user data has been erased. In other words, the method may comprise providing 165 the information on the verification that the user data has been erased. For example, this information may be output by the firmware (e.g., via a network interface or management interface, or via a local peripheral interface (such as a Universal Serial Bus port)). In FIG. 3, the documentation is provided via Web App storage being part of a component 332 of the remote management firmware 330.

In general, both erasing the user data and documenting the procedure may be done for the purpose of satisfying a government regulation, such as NIST (National Institute of Standards and Technology) 800-88r1. NIST Special Publication 800-88 Revision 1, titled “Guidelines for Media Sanitization,” is a document that provides guidance on how to effectively sanitize different types of digital media, ensuring that sensitive data is properly cleared, purged, or destroyed according to applicable regulations or needs. The purpose of NIST 800-88r1 is to assist organizations in developing and implementing media sanitization practices to prevent unauthorized access to confidential or sensitive data when a storage medium is repurposed, transferred, recycled, or disposed of. For the purposes of the present disclosure, the entirety of the computer system, including storage circuitry used by the OS and storage circuitry managed by a non-OS component, may be considered such a storage medium. NIST 800-88r1 specifies different levels of requirements for erasing data, such as data clearing, data purging and destroying. The proposed technique may be used for at least the first two options, data clearing and data purging, for example. For example, the information on the verification that the user data has been erased indicates that the user data has been purged in alignment with NIST 800-88r1, e.g., to document that the user data has been cleared or purged.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processor circuitry 14 or means for processing 14 may be implemented using one or more processing units, one or more processing devices, any means for processing, such as a processor, a computer or a programmable hardware component being operable with accordingly adapted software. In other words, the described function of the processor circuitry 14 or means for processing may as well be implemented in software, which is then executed on one or more programmable hardware components. Such hardware components may comprise a general-purpose processor, a Digital Signal Processor (DSP), a micro-controller, etc.

For example, the memory or storage circuitry 16 or means for storing information 16 may a volatile memory, e.g., random access memory, such as dynamic random-access memory (DRAM), and/or comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

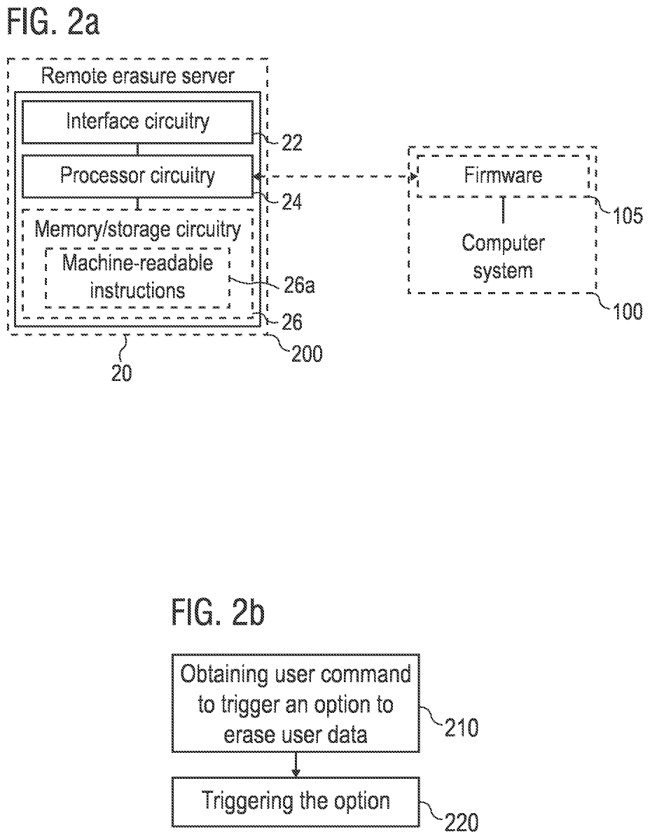

More details and aspects of the apparatus 10, device 10, computer system 100, method and computer program are mentioned in connection with the proposed concept, or one or more examples described above or below (e.g., FIGS. 1, 2a to 2b). The apparatus 10, device 10, computer system 100, method and computer program may comprise one or more additional optional features corresponding to one or more aspects of the proposed concept, or one or more examples described above or below.

FIG. 2a shows a schematic diagram of an example of an apparatus 20 or device 20 for a remote erasure server 200, and of the remote erasure server 200 comprising the apparatus 20 or device 20. The apparatus 20 comprises circuitry to provide the functionality of the apparatus 20. For example, the circuitry of the apparatus 20 may be configured to provide the functionality of the apparatus 20. For example, the apparatus 20 of FIG. 2a comprises interface circuitry 22, processor circuitry 24, and (optional) memory/storage circuitry 26. For example, the processor circuitry 24 may be coupled with the interface circuitry 22 and/or with the memory/storage circuitry 26. For example, the processor circuitry 24 may provide the functionality of the apparatus, in conjunction with the interface circuitry 22 (for communicating with other entities inside or outside the remote erasure server 200, such as a firmware 105 of a computer system 100), and the memory/storage circuitry 26 (for storing information, such as machine-readable instructions). Likewise, the device 20 may comprise means for providing the functionality of the device 20. For example, the means may be configured to provide the functionality of the device 20. The components of the device 20 are defined as component means, which may correspond to, or implemented by, the respective structural components of the apparatus 20. For example, the device 20 of FIG. 2a comprises means for processing 24, which may correspond to or be implemented by the processor circuitry 24, means for communicating 22, which may correspond to or be implemented by the interface circuitry 22, (optional) means for storing information 26, which may correspond to or be implemented by the memory or storage circuitry 26. In general, the functionality of the processor circuitry 24 or means for processing 24 may be implemented by the processor circuitry 24 or means for processing 24 executing machine-readable instructions. Accordingly, any feature ascribed to the processor circuitry 24 or means for processing 24 may be defined by one or more instructions of a plurality of machine-readable instructions. The apparatus 20 or device 20 may comprise the machine-readable instructions 26a, e.g., within the memory or storage circuitry 26 or means for storing information 26.

The processor circuitry 24 or means for processing 24 is to obtain a user command to trigger an option for a user of a computer system 100 to erase user data of the computer system. The processor circuitry 24 or means for processing 24 is to trigger, via a computer network, the option for the user of a computer system to erase user data of the computer system via an interface provided by a firmware 105 of the computer system.

FIG. 2b shows a flow chart of an example of a corresponding method for the remote erasure server 200. The method comprises obtaining 210 a user command to trigger an option for a user of a computer system to erase user data of the computer system. The method comprises triggering 220, via a computer network, the option for the user of a computer system to erase user data of the computer system via an interface provided by a firmware of the computer system. For example, the method may be performed by the remote erasure server 200.

The interface circuitry 22 or means for communicating 22 may correspond to one or more inputs and/or outputs for receiving and/or transmitting information, which may be in digital (bit) values according to a specified code, within a module, between modules or between modules of different entities. For example, the interface circuitry 22 or means for communicating 22 may comprise circuitry configured to receive and/or transmit information.

For example, the processor circuitry 24 or means for processing 24 may be implemented using one or more processing units, one or more processing devices, any means for processing, such as a processor, a computer or a programmable hardware component being operable with accordingly adapted software. In other words, the described function of the processor circuitry 24 or means for processing may as well be implemented in software, which is then executed on one or more programmable hardware components. Such hardware components may comprise a general-purpose processor, a Digital Signal Processor (DSP), a micro-controller, etc.

For example, the memory or storage circuitry 26 or means for storing information 26 may a volatile memory, e.g., random access memory, such as dynamic random-access memory (DRAM), and/or comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the apparatus 20, device 20, remote erasure server 200, method and computer program are mentioned in connection with the proposed concept, or one or more examples described above or below (e.g., FIGS. 1 to 1b). The apparatus 20, device 20, remote erasure server 200, method and computer program may comprise one or more additional optional features corresponding to one or more aspects of the proposed concept, or one or more examples described above or below.

Various examples of the present disclosure relate to a concept for platform hardware sanitization while preserving or restoring the operating system of the computer system. The proposed concept may allow for the full erase of the platform and the OS operation to be restored or preserved. It may also allow for the user to select which elements can be erased or preserved, both at the OS-level file system and at the platform level.

Apple has provided end users with the ability to erase their platform's SSD (Solid-State Drive) and reinstall a MacOS to the device via an onboard utility. This enables a self-service model and easy to follow UI. Apple has an advantage in that they own the 1) platform 2) OS 3) a cloud platform to host the OS for reinstallation.

Google Chrome platforms provides “Power-wash” which erases the user storage partition. The OS remains intact. Google has an advantage for their Chromebooks in that they own the OS with tight control on how the local user's data is stored on the platform's storage media and via remote storage.

The open PC (Personal Computer) ecosystem can have various Platform Erase solutions with many different delivery methods, but this ecosystem openness provides unique challenges that one single implementation cannot satisfy due to the various vendors involved and the fragmentation across the resulting PC platform.

On non-Apple or non-Chrome PCs, UEFI BIOS-based platform erase methods blindly remove the OS as well as user personal data when erasing storage media. To restore the device to a usable operating state, someone with OS install know-how and the associated OS licensing key may be required. In large commercial enterprises, the IT organization may have a working agreement with their PC OEM (Original Equipment Manufacturer) suppliers and OS vendors to provide tools to reinstall licensed OSs. This would allow for a path to restore the PC to an operational state for the next user.

Going forward, sustainability logos like EPEAT (Electronic Product Environmental Assessment Tool) expect platforms to provide easy to follow storage media erase instructions along with platform operation (i.e., OS install) restoration, free of charge. Some platform-based solutions in the PC ecosystem may fall short of EPEAT expectations set for 2025. The proposed concept will enable quick instructions performed locally or remotely.

The proposed concept may provide platform hardware Sanitization while preserving or restoring the OS. The proposed concept (of which an example is shown in FIG. 1) may integrate the OS Factory Reset Mode capability into the platform erase methods at the BIOS level (i.e., at the firmware), which can be triggered remotely or locally through the BIOS menu (i.e., the user interface of the firmware). The local erase feature may be triggered through the OS as well.

Some examples of the proposed concept may allow the user to select which files, directory partitions, application configurations both in the OS-level and the hardware platform level can be preserved or erased.

This platform level approach may provide a self-contained mechanism to not only erase the storage media but also SoC secrets which should only be present for the specific user context. The proposed concept may also preserve or reinstates the OS operation and any files and folders specified by the user.

The proposed concept may provide a comprehensive hardware IP (Intellectual Property) and OS-Level/User Data erase approach while preserving or restoring the platform's operation. The proposed concept may thus provide a comprehensive platform erase approach which services OS-level user data, user installed apps and their associated HW-platform components (licensing keys, encryption keys, BIOS variables/settings, etc.). In some examples, the proposed concept may reset any CSME (Converged Security Management Engine) provisioned services, configurations in a partial or full manner. Intel's TSE keys can also be handled appropriately given the OS Factory Reset Mode option selection. Various examples of the present disclosure may be implemented via a BIOS setup menu, an operating system menu, or a Software Development Kit of a platform vendor, and documented in the firmware code and reference documentation.

FIG. 3 shows a schematic diagram of an architectural overview of various components that can be used for implementing the proposed concept. FIG. 3 shows the UEFI BIOS 300 with a “Platform Erase Actions” block 310. The Platform Erase Actions block 310 comprises a proposed component 312, e.g., the apparatus 10 or device 10 shown in connection with FIG. 1a, which comprises functionality to clear user data/apps/credentials and to restore the OS to a factory state. Platform Erase Actions block 310 comprises a hardware component erase block 314, which provides functionality for clearing the Trusted Platform Module (TPM), reloading the BIOS Gold Configuration, un-configuring (e.g., resetting) the OOB (Out-of-Band) EC (Embedded Controller), clearing the non-volatile memory (NVM) variables and performing an OEM custom erase. Platform Erase Actions block 310 comprises a NIST 800-88r1 Storage Media Sanitization block 316, comprising functionality to performing purging, verification and documentation according to NIST 800-88r1. Platform Erase Actions block 310 comprises a local UI BIOS menu 318 (for providing the option to erase the user data locally for a user). FIG. 3 further shows an Operating System (OS) 320, which comprises a component 325 (also proposed) to perform an OS factory reset (i.e., an OS factory reset mode). FIG. 3 further shows a CSME (Converged Security and Management Engine) 330, which is analogous to an embedded controller (EC), and which comprises an OOB Pre-OS component 332 for providing a remote platform erase (RPE) API (Application Programming Interface), which sets RPE BIOS Flags, and Event Log (for logging the RPE API and logging information provided by the Platform Erase Actions Block 310, and Web App storage, where a sanitization report is stored by the functionality for performing documentation according to NIST 800-88r1. The CSME 330 further comprises an event ledger 334 for storing persistent records on information on a last platform erase event, storage erase, TPM clear, BIOS Gold configuration, CSME unconfigure, clear BIOS variables, OEM custom erase, storage erase verification, and Microsoft OS factory reset events. FIG. 3 further shows a management console 340 (e.g., at the remote erasure server), which provides functionality for remote platform erase UX (triggering the RPE API at the OOB Pre-OS component 332), obtaining information on a status of the RPE (by reading from the event log maintained by the OOB Pre-OS component 332) and retrieving the sanitization report (by reading from the Web App storage maintained by the OOB Pre-OS component 332).

In FIG. 3, the UEFI BIOS pre-OS approach is shown in the “Platform Erase Actions” box. The smaller boxes within form detailed Platform Sanitization capabilities that perform one or more of the following operations: (1) Sanitize, erase, or reset key platform components including Storage, TPM (Trusted Platform Module), CSME, BIOS Gold Configuration reset, UEFI BIOS variable Reset, & OEM custom action. (2) Provide a platform persistent record of the last time the key platform components were sanitized, erased, or reset. (3) Provide a remote capability to perform platform component sanitization (in FIG. 1 through Active Management Technology but could be through some other interface). (4) Provide local platform component sanitization through pre-boot user experience. (5) Perform Storage Purge, Verification, and Generation of Proof in alignment to NIST (National Institute of Standards and Technology) 800-88r1 specification to aid in compliance to device disposal guidelines.

The proposed concept relates to the integration of the above with the OS and its erase and factory reset capabilities. This may provide an overall hardware-level and software OS file system and installed app level erase which cannot be accomplished with UEFI and the OS working separately. Some examples may provide no preservation. Some examples may provide AMT Clean Provision for IT Shop-Remote Management (CSME). Some examples may perform a BIOS Reset, e.g., with respect to Power On Passwords.

More details and aspects of the concept for platform hardware sanitization while preserving or restoring the operating system are mentioned in connection with the proposed concept, or one or more examples described above or below (e.g., FIG. 1a to 2b). The concept for platform hardware sanitization while preserving or restoring the operating system may comprise one or more additional optional features corresponding to one or more aspects of the proposed concept, or one or more examples described above or below.

In the following, some examples of the proposed concept are presented:

An example (e.g., example 1) relates to an apparatus (10) for a computer system (100), the apparatus comprising interface circuitry (12), machine-readable instructions, and processor circuitry (14) to execute the machine-readable instructions to provide, via an interface of a firmware (105) of the computer system, an option to erase user data of the computer system, and erase, after the option has been triggered, the user data of the computer system, wherein erasing the user data of the computer system comprises erasing user data managed by a non-operating system component of the computer system and erasing user data managed by an operating system of the computer system.

Another example (e.g., example 2) relates to a previous example (e.g., example 1) or to any other example, further comprising that the option is provided by one of a Unified Extensible Firmware Interface, UEFI, of the computer system, a Basic Input/Output System, BIOS, of the computer system, and a remote management firmware of the computer system.

Another example (e.g., example 3) relates to a previous example (e.g., one of the examples 1 or 2) or to any other example, further comprising that the processor circuitry is to execute the machine-readable instructions to provide, via a user interface of the firmware of the computer system, the option for a user of the computer system to erase the user data as a menu option, and to erase, after the user has triggered the menu option, the user data of the computer system.

Another example (e.g., example 4) relates to a previous example (e.g., one of the examples 1 to 3) or to any other example, further comprising that the processor circuitry is to execute the machine-readable instructions to provide, via the interface of the firmware of the computer system, the option to erase the user data of the computer system via an operating system of the computer system, and to erase, after the option has been triggered via the operating system, the user data of the computer system.

Another example (e.g., example 5) relates to a previous example (e.g., one of the examples 1 to 4) or to any other example, further comprising that the processor circuitry is to execute the machine-readable instructions to provide, via the interface of the firmware of the computer system, the option to erase the user data of the computer system via a remote erasure server or a remote management system, and to erase, after the option has been triggered via the remote erasure server or the remote management system, the user data of the computer system.

Another example (e.g., example 6) relates to a previous example (e.g., one of the examples 1 to 5) or to any other example, further comprising that erasing the user data managed by a non-operating system component of the computer system includes erasing and/or restoring to a default at least one of user data stored in a trusted platform module of the computer system, user data stored in a trusted execution environment of the computer system, user stored in a security engine of the computer system, user configuration settings stored in a non-volatile memory of the computer system, user configuration settings stored by a firmware or firmware application of the computer system, and user data related to one or more authentication variables.

Another example (e.g., example 7) relates to a previous example (e.g., one of the examples 1 to 6) or to any other example, further comprising that erasing the user data managed by a non-operating system component of the computer system comprises restoring factory settings of the computer system.

Another example (e.g., example 8) relates to a previous example (e.g., one of the examples 1 to 7) or to any other example, further comprising that erasing user data managed by the operating system of the computer system comprises triggering the operating system of the computer system to erase the user data managed by the operating system.

Another example (e.g., example 9) relates to a previous example (e.g., example 8) or to any other example, further comprising that in case the trigger is obtained from the operating system of the computer system, erasing the user data managed by the operating system of the computer system is triggered and performed by the operating system.

Another example (e.g., example 10) relates to a previous example (e.g., one of the examples 1 to 9) or to any other example, further comprising that erasing the user data comprises performing one or more user data erasure operations defined by a vendor of the computer system.

Another example (e.g., example 11) relates to a previous example (e.g., one of the examples 1 to 10) or to any other example, further comprising that the processor circuitry is to execute the machine-readable instructions to provide, via the interface, an option to select which user data is to be erased.

Another example (e.g., example 12) relates to a previous example (e.g., one of the examples 1 to 11) or to any other example, further comprising that the operating system of the computer system is preserved or reset to a factory default when the user data is erased.

Another example (e.g., example 13) relates to a previous example (e.g., one of the examples 1 to 12) or to any other example, further comprising that the processor circuitry is to execute the machine-readable instructions to determine the user data to be erased based on information on a proposal of user data to be erased by a platform vendor of the computer system.

Another example (e.g., example 14) relates to a previous example (e.g., one of the examples 1 to 13) or to any other example, further comprising that the processor circuitry is to execute the machine-readable instructions to write a persistent record of a timestamp of when the user data has been erased to a storage circuitry of the computer system.

Another example (e.g., example 15) relates to a previous example (e.g., one of the examples 1 to 14) or to any other example, further comprising that the processor circuitry is to execute the machine-readable instructions to verify that the user data has been erased.

Another example (e.g., example 16) relates to a previous example (e.g., example 15) or to any other example, further comprising that the processor circuitry is to execute the machine-readable instructions to provide information on the verification that the user data has been erased.

Another example (e.g., example 17) relates to a previous example (e.g., example 16) or to any other example, further comprising that the information on the verification that the user data has been erased indicates that the user data has been purged in alignment with NIST 800-88r1.

An example (e.g., example 18) relates to an apparatus (10) for a computer system (100), the apparatus comprising processor circuitry (14) configured to provide, via an interface of a firmware (105) of the computer system, an option to erase user data of the computer system, and erase, after the option has been triggered, the user data of the computer system, wherein erasing the user data of the computer system comprises erasing user data managed by a non-operating system component of the computer system and erasing user data managed by an operating system of the computer system.

An example (e.g., example 19) relates to a device (10) for a computer system (100), the device comprising means for processing (14) for providing, via an interface of a firmware (105) of the computer system, an option to erase user data of the computer system, and erasing, after the option has been triggered, the user data of the computer system, wherein erasing the user data of the computer system comprises erasing user data managed by a non-operating system component of the computer system and erasing user data managed by an operating system of the computer system.

Another example (e.g., example 20) relates to a computer system (100), comprising the apparatus (10) or device (10) according to one of the examples 1 to 19 (or according to any other example).

An example (e.g., example 21) relates to a method for a computer system (100), the method comprising providing (110), via an interface of a firmware (105) of the computer system, an option to erase user data of the computer system, and erasing (140), after the option has been triggered (120), the user data of the computer system, wherein erasing the user data of the computer system comprises erasing (142) user data managed by a non-operating system component of the computer system and erasing (144) user data managed by an operating system of the computer system.

Another example (e.g., example 22) relates to a previous example (e.g., example 21) or to any other example, further comprising that the option is provided by one of a Unified Extensible Firmware Interface, UEFI, of the computer system, a Basic Input/Output System, BIOS, of the computer system, and a remote management firmware of the computer system.

Another example (e.g., example 23) relates to a previous example (e.g., one of the examples 21 or 22) or to any other example, further comprising that the method comprises providing (110), via a user interface of the firmware of the computer system, the option for a user of the computer system to erase the user data as a menu option, and erasing (140), after the user has triggered the menu option, the user data of the computer system.

Another example (e.g., example 24) relates to a previous example (e.g., one of the examples 21 to 23) or to any other example, further comprising that the method comprises providing (110), via the interface of the firmware of the computer system, the option to erase the user data of the computer system via an operating system of the computer system, and erasing (140), after the option has been triggered via the operating system, the user data of the computer system.

Another example (e.g., example 25) relates to a previous example (e.g., one of the examples 21 to 24) or to any other example, further comprising that the method comprises providing (110), via the interface of the firmware of the computer system, the option to erase the user data of the computer system via a remote erasure server or a remote management system, and erasing (140), after the option has been triggered via the remote erasure server or the remote management system, the user data of the computer system.

Another example (e.g., example 26) relates to a previous example (e.g., one of the examples 21 to 25) or to any other example, further comprising that erasing the user data managed by a non-operating system component of the computer system includes erasing and/or restoring to a default at least one of user data stored in a trusted platform module of the computer system, user data stored in a trusted execution environment of the computer system, user stored in a security engine of the computer system, user configuration settings stored in a non-volatile memory of the computer system, user configuration settings stored by a firmware or firmware application of the computer system, and user data related to one or more authentication variables.

Another example (e.g., example 27) relates to a previous example (e.g., one of the examples 21 to 26) or to any other example, further comprising that erasing the user data managed by a non-operating system component of the computer system comprises restoring (146) factory settings of the computer system.

Another example (e.g., example 28) relates to a previous example (e.g., one of the examples 21 to 27) or to any other example, further comprising that erasing (144) user data managed by the operating system of the computer system comprises triggering the operating system of the computer system to erase the user data managed by the operating system.

Another example (e.g., example 29) relates to a previous example (e.g., example 28) or to any other example, further comprising that in case the trigger is obtained from the operating system of the computer system, erasing the user data managed by the operating system of the computer system is triggered and performed by the operating system.

Another example (e.g., example 30) relates to a previous example (e.g., one of the examples 21 to 29) or to any other example, further comprising that erasing the user data comprises performing (148) one or more user data erasure operations defined by a vendor of the computer system.

Another example (e.g., example 31) relates to a previous example (e.g., one of the examples 21 to 30) or to any other example, further comprising that the method comprises providing (115), via the interface, an option to select which user data is to be erased.

Another example (e.g., example 32) relates to a previous example (e.g., one of the examples 21 to 31) or to any other example, further comprising that the operating system of the computer system is preserved or reset to a factory default when the user data is erased.

Another example (e.g., example 33) relates to a previous example (e.g., one of the examples 21 to 32) or to any other example, further comprising that the method comprises determining (130) the user data to be erased based on information on a proposal of user data to be erased by a platform vendor of the computer system.

Another example (e.g., example 34) relates to a previous example (e.g., one of the examples 21 to 33) or to any other example, further comprising that the method comprises writing (150) a persistent record of a timestamp of when the user data has been erased to a storage circuitry of the computer system.

Another example (e.g., example 35) relates to a previous example (e.g., one of the examples 21 to 34) or to any other example, further comprising that the method comprises verifying (160) that the user data has been erased.

Another example (e.g., example 36) relates to a previous example (e.g., example 35) or to any other example, further comprising that the method comprises providing (165) information on the verification that the user data has been erased.

Another example (e.g., example 37) relates to a previous example (e.g., example 36) or to any other example, further comprising that the information on the verification that the user data has been erased indicates that the user data has been purged in alignment with NIST 800-88r1.

An example (e.g., example 38) relates to a computer system (100) to execute the method of one of the examples 21 to 37 (or according to any other example).

An example (e.g., example 39) relates to an apparatus (20) for a remote erasure server (200), the apparatus (20) comprising interface circuitry (22), machine-readable instructions, and processor circuitry (24) to execute the machine-readable instructions to obtain a user command to trigger an option for a user of a computer system (100) to erase user data of the computer system, and trigger, via a computer network, the option for the user of a computer system to erase user data of the computer system via an interface provided by a firmware (205) of the computer system.

An example (e.g., example 40) relates to an apparatus (20) for a remote erasure server (200), the apparatus (20) comprising processor circuitry (24) configured to obtain a user command to trigger an option for a user of a computer system to erase user data of the computer system, and trigger, via a computer network, the option for the user of a computer system to erase user data of the computer system via an interface provided by a firmware of the computer system.

An example (e.g., example 41) relates to a device (20) for a remote erasure server (200), the device (20) comprising means for processing (24) for obtaining a user command to trigger an option for a user of a computer system to erase user data of the computer system, and triggering, via a computer network, the option for the user of a computer system to erase user data of the computer system via an interface provided by a firmware of the computer system.

Another example (e.g., example 42) relates to a remote erasure server (200) comprising the apparatus (20) or device (20) according to one of the examples 39 to 41.

An example (e.g., example 43) relates to a method for a remote erasure server (200), the method comprising obtaining (210) a user command to trigger an option for a user of a computer system to erase user data of the computer system, and triggering (220), via a computer network, the option for the user of a computer system to erase user data of the computer system via an interface provided by a firmware of the computer system.

An example (e.g., example 44) relates to a remote erasure server (200) to execute the method of example 43 (or according to any other example)

Another example (e.g., example 45) relates to a non-transitory, computer-readable medium comprising a program code that, when the program code is executed on a processor, a computer, or a programmable hardware component, causes the processor, computer, or programmable hardware component to perform the method of one of the examples 21 to 37 (or of any other example) or the method of example 43 (or of any other example).

Another example (e.g., example 46) relates to a non-transitory machine-readable storage medium including program code, when executed, to cause a machine to perform the method of one of the examples 21 to 37 (or of any other example) or the method of example 43 (or of any other example).

Another example (e.g., example 47) relates to a computer program having a program code for performing the method of one of the examples 21 to 37 (or of any other example) or the method of example 43 (or of any other example) when the computer program is executed on a computer, a processor, or a programmable hardware component.

Another example (e.g., example 48) relates to a machine-readable storage including machine readable instructions, when executed, to implement a method or realize an apparatus as claimed in any pending claim or shown in any example.

An example (e.g., example A1) relates to an apparatus (10) for a computer system (100), the apparatus comprising interface circuitry (12), machine-readable instructions, and processor circuitry (14) to execute the machine-readable instructions to provide, via an interface of a firmware (105) of the computer system, an option for a user of the computer system to erase user data of the computer system, and erase, after a user has triggered the option, the user data of the computer system.

Another example (e.g., example A2) relates to a previous example (e.g., example A1) or to any other example, further comprising that the menu option is provided in a Unified Extensible Firmware Interface, UEFI, of the computer system.

Another example (e.g., example A3) relates to a previous example (e.g., one of the examples A1 or A2) or to any other example, further comprising that erasing the user data includes erasing at least one of user data stored on a storage partition of the computer system, user data stored in a trusted platform module of the computer system, user data stored in a trusted execution environment of the computer system, user stored in a security engine of the computer system, user configuration settings stored in a non-volatile memory of the computer system, and user configuration settings stored by a firmware or firmware application of the computer system.

Another example (e.g., example A4) relates to a previous example (e.g., one of the examples A1 to A3) or to any other example, further comprising that erasing the user data comprises restoring factory settings of the computer system.

Another example (e.g., example A5) relates to a previous example (e.g., one of the examples A1 to A4) or to any other example, further comprising that erasing the user data comprises performing one or more vendor-defined user data erasure operations defined by a vendor of the computer system.

Another example (e.g., example A6) relates to a previous example (e.g., one of the examples A1 to A5) or to any other example, further comprising that erasing the user data comprises triggering a main operating system of the computer system to erase user data.

Another example (e.g., example A7) relates to a previous example (e.g., one of the examples A1 to A6) or to any other example, further comprising that the processor circuitry (14) is to execute the machine-readable instructions to provide, via the interface, the user an option to select which user data is to be erased.

Another example (e.g., example A8) relates to a previous example (e.g., one of the examples A1 to A7) or to any other example, further comprising that the processor circuitry (14) is to execute the machine-readable instructions to provide, via a user interface of the firmware (105) of the computer system, the option for a user of the computer system to erase the user data of the computer system as a menu option, and to erase, after the user has triggered the menu option, the user data of the computer system.

Another example (e.g., example A9) relates to a previous example (e.g., one of the examples A1 to A8) or to any other example, further comprising that the processor circuitry (14) is to execute the machine-readable instructions to provide, via the interface of the firmware (105) of the computer system, the option for a user of the computer system to erase the user data of the computer system via a remote erasure server and a computer network, and to erase, after the user has triggered the option via the remote erasure server, the user data of the computer system.

Another example (e.g., example A10) relates to a previous example (e.g., one of the examples A1 to A9) or to any other example, further comprising that the processor circuitry (14) is to execute the machine-readable instructions to provide, via the interface of the firmware (105) of the computer system, the option for a user of the computer system to erase the user data of the computer system via a main operating system of the computer system, and to erase, after the user has triggered the option via the main operating system, the user data of the computer system.

Another example (e.g., example A11) relates to a previous example (e.g., one of the examples A1 to A10) or to any other example, further comprising that a main operating system of the computer system is preserved or reset to a factory default.

An example (e.g., example A12) relates to an apparatus (10) for a computer system (100), the apparatus processor circuitry (14) configured to provide, via an interface of a firmware (105) of the computer system, an option for a user of the computer system to erase user data of the computer system, and erase, after a user has triggered the option, the user data of the computer system.

An example (e.g., example A13) relates to a device (10) for a computer system (100), the device comprising means for processing for providing, via an interface of a firmware (105) of the computer system, an option for a user of the computer system to erase user data of the computer system, and erasing, after a user has triggered the option, the user data of the computer system.

Another example (e.g., example A14) relates to a computer system (100) comprising the apparatus (10) or device (10) according to one of the examples A1 to A13.

An example (e.g., example A15) relates to a method for a computer system (100), the method comprising Providing (110), via an interface of a firmware (105) of the computer system, an option for a user of the computer system to erase user data of the computer system, and Erasing (140), after a user has triggered the option, the user data of the computer system.

Another example (e.g., example A16) relates to a computer system (100) being configured to perform the method of example A15.

An example (e.g., example A17) relates to an apparatus (20) for a remote erasure server (200), the apparatus (20) comprising interface circuitry (22), machine-readable instructions, and processor circuitry (24) to execute the machine-readable instructions to obtain a user command to trigger an option for a user of a computer system (100) to erase user data of the computer system, and trigger, via a computer network, the option for the user of a computer system to erase user data of the computer system via an interface provided by a firmware (105) of the computer system.

An example (e.g., example A18) relates to an apparatus (20) for a remote erasure server (200), the apparatus (20) comprising processor circuitry (24) configured to obtain a user command to trigger an option for a user of a computer system to erase user data of the computer system, and trigger, via a computer network, the option for the user of a computer system to erase user data of the computer system via an interface provided by a firmware of the computer system.

An example (e.g., example A19) relates to a device (20) for a remote erasure server (200), the device (20) comprising means for processing (24) for obtaining a user command to trigger an option for a user of a computer system to erase user data of the computer system, and triggering, via a computer network, the option for the user of a computer system to erase user data of the computer system via an interface provided by a firmware of the computer system.

An example (e.g., example A20) relates to a method for a remote erasure server (200), the method comprising Obtaining (210) a user command to trigger an option for a user of a computer system to erase user data of the computer system, and Triggering (220), via a computer network, the option for the user of a computer system to erase user data of the computer system via an interface provided by a firmware of the computer system.

Another example (e.g., example A21) relates to a non-transitory, computer-readable medium comprising a program code that, when the program code is executed on a processor, a computer, or a programmable hardware component, causes the processor, computer, or programmable hardware component to perform the method of example A15 or the method of example A20.

Another example (e.g., example A22) relates to a non-transitory machine-readable storage medium including program code, when executed, to cause a machine to perform the method of example A15 or the method of example A20.

Another example (e.g., example A23) relates to a computer program having a program code for performing the method of example A15 or the method of example A20 when the computer program is executed on a computer, a processor, or a programmable hardware component.

Another example (e.g., example A24) relates to a machine-readable storage including machine readable instructions, when executed, to implement a method or realize an apparatus as claimed in any pending claim.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for a computer system, the apparatus comprising interface circuitry, machine-readable instructions, and processor circuitry to execute the machine-readable instructions to:
provide, via an interface of a firmware of the computer system, an option to erase user data of the computer system; and
erase, after the option has been triggered, the user data of the computer system, wherein erasing the user data of the computer system comprises erasing user data managed by a non-operating system component of the computer system and erasing user data managed by an operating system of the computer system.

2. The apparatus according to claim 1, wherein the option is provided by one of a Unified Extensible Firmware Interface, UEFI, of the computer system, a Basic Input/Output System, BIOS, of the computer system, and a remote management firmware of the computer system.

3. The apparatus according to claim 1, wherein the processor circuitry is to execute the machine-readable instructions to provide, via a user interface of the firmware of the computer system, the option for a user of the computer system to erase the user data as a menu option, and to erase, after the user has triggered the menu option, the user data of the computer system.

4. The apparatus according to claim 1, wherein the processor circuitry is to execute the machine-readable instructions to provide, via the interface of the firmware of the computer system, the option to erase the user data of the computer system via an operating system of the computer system, and to erase, after the option has been triggered via the operating system, the user data of the computer system.

5. The apparatus according to claim 1, wherein the processor circuitry is to execute the machine-readable instructions to provide, via the interface of the firmware of the computer system, the option to erase the user data of the computer system via a remote erasure server or a remote management system, and to erase, after the option has been triggered via the remote erasure server or the remote management system, the user data of the computer system.

6. The apparatus according to claim 1, wherein erasing the user data managed by a non-operating system component of the computer system includes erasing and/or restoring to a default at least one of user data stored in a trusted platform module of the computer system, user data stored in a trusted execution environment of the computer system, user stored in a security engine of the computer system, user configuration settings stored in a non-volatile memory of the computer system, user configuration settings stored by a firmware or firmware application of the computer system, and user data related to one or more authentication variables.

7. The apparatus according to claim 1, wherein erasing the user data managed by a non-operating system component of the computer system comprises restoring factory settings of the computer system.

8. The apparatus according to claim 1, wherein erasing user data managed by the operating system of the computer system comprises triggering the operating system of the computer system to erase the user data managed by the operating system.

9. The apparatus according to claim 8, wherein, in case the trigger is obtained from the operating system of the computer system, erasing the user data managed by the operating system of the computer system is triggered and performed by the operating system.

10. The apparatus according to claim 1, wherein erasing the user data comprises performing one or more user data erasure operations defined by a vendor of the computer system.

11. The apparatus according to claim 1, wherein the processor circuitry is to execute the machine-readable instructions to provide, via the interface, an option to select which user data is to be erased.

12. The apparatus according to claim 1, wherein the operating system of the computer system is preserved or reset to a factory default when the user data is erased.

13. The apparatus according to claim 1, wherein the processor circuitry is to execute the machine-readable instructions to determine the user data to be erased based on information on a proposal of user data to be erased by a platform vendor of the computer system.

14. The apparatus according to claim 1, wherein the processor circuitry is to execute the machine-readable instructions to write a persistent record of a timestamp of when the user data has been erased to a storage circuitry of the computer system.

15. The apparatus according to claim 1, wherein the processor circuitry is to execute the machine-readable instructions to verify that the user data has been erased.

16. The apparatus according to claim 15, wherein the processor circuitry is to execute the machine-readable instructions to provide information on the verification that the user data has been erased.

17. The apparatus according to claim 16, wherein the information on the verification that the user data has been erased indicates that the user data has been purged in alignment with NIST 800-88r1.

18. An apparatus for a remote erasure server, the apparatus comprising interface circuitry, machine-readable instructions, and processor circuitry to execute the machine-readable instructions to:
obtain a user command to trigger an option for a user of a computer system to erase user data of the computer system; and
trigger, via a computer network, the option for the user of a computer system to erase user data of the computer system via an interface provided by a firmware of the computer system.

19. A method for a computer system, the method comprising:
providing, via an interface of a firmware of the computer system, an option to erase user data of the computer system; and
erasing, after the option has been triggered, the user data of the computer system, wherein erasing the user data of the computer system comprises erasing user data managed by a non-operating system component of the computer system and erasing user data managed by an operating system of the computer system.

20. A non-transitory, computer-readable medium comprising a program code that, when the program code is executed on a processor, a computer, or a programmable hardware component, causes the processor, computer, or programmable hardware component to perform the method of claim 19.
